(19) United States
(12) Patent Application Publication
(10) Pub. No.: US 2018/0121577 A1
(43) Pub. Date: May 3, 2018

(54) SYSTEMS AND METHODS FOR PROVIDING FORECASTS INCORPORATING SEASONALITY

(71) Applicant: Facebook, Inc., Menlo Park, CA (US)

(72) Inventors: Sean Jude Taylor, San Francisco, CA (US); Thomas Benjamin Letham, Redwood City, CA (US); Sanghyeon Park, Oakland, CA (US); Stephen M. DeLucia, San Francisco, CA (US)

(21) Appl. No.: 15/341,844

(22) Filed: Nov. 2, 2016

(51) Int. Cl. G06F 17/50; G06N 99/00

(52) U.S. Cl. CPC G06F 17/5009; G06N 99/005

(57) ABSTRACT

Systems, methods, and non-transitory computer readable media can obtain a plurality of change points that are each indicative of a potential change in a curve relating to a metric associated with a system. A prediction model for providing forecasts relating to the metric can be generated. A seasonality model for predicting seasonality associated with the metric can be generated. A combined forecast model can be generated based on the prediction model and the seasonality model.

### FIELD OF THE INVENTION

The present technology relates to the field of social networks. More particularly, the present technology relates to techniques for providing forecasts associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A user can operate a computing device to build forecasting models for a time series data set. A time series generally includes a sequence of data points consisting of successive measurements that are made over some period of time, such as the price of a stock that is measured daily over a year. Such forecasting models can be used to estimate, or predict, future values based on the previously observed values that are included in the time series data set.

### SUMMARY

Various embodiments of the present disclosure can include systems, methods, and non-transitory computer readable media configured to obtain a plurality of change points that are each indicative of a potential change in a curve relating to a metric associated with a system. A prediction model for providing forecasts relating to the metric can be generated. A seasonality model for predicting seasonality associated with the metric can be generated. A combined forecast model can be generated based on the prediction model and the seasonality model.

In some embodiments, the plurality of change points are provided as dates.

In certain embodiments, the plurality of change points are determined based on a machine learning model.

In an embodiment, the prediction model is a machine learning model, and the machine learning model is trained based on training data relating to the metric.

In some embodiments, the plurality of change points indicate one or more segments in the training data for training the machine learning model.

In certain embodiments, the seasonality model is a machine learning model, and the machine learning model is trained based on training data relating to seasonality associated with the metric.

In an embodiment, a plurality of holidays and events that are each indicative of a potential change in the curve relating to the metric are obtained.

In some embodiments, the growth model and the seasonality model are iteratively fit based on historical data to generate the combined forecast model.

In certain embodiments, capacity data relating to one or more components included in the prediction model is obtained, wherein the forecasts relating to the metric are determined based on the one or more components.

In an embodiment, the metric relates to a growth rate associated with growth of users of the system, and the system is a social networking system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example forecast module configured to provide forecasts associated with a social networking system, according to an embodiment of the present disclosure.

FIG. 2A illustrates an example growth module configured to model growth associated with a social networking system, according to an embodiment of the present disclosure.

FIG. 2B illustrates an example seasonality module configured to model seasonality associated with a social networking system, according to an embodiment of the present disclosure.

FIG. 2C illustrates an example growth forecast module configured to forecast growth associated with a social networking system, according to an embodiment of the present disclosure.

FIG. 3 illustrates an example scenario for providing forecasts associated with a social networking system, according to an embodiment of the present disclosure.

FIG. 4 illustrates an example first method for providing forecasts associated with a social networking system, according to an embodiment of the present disclosure.

FIG. 5 illustrates an example second method for providing forecasts associated with a social networking system, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Forecasts Incorporating Seasonality in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide user profiles for various users through which users may add connections, such as friends, or publish content items.

Conventional approaches specifically arising in the realm of computer technology can provide forecasts associated with a social networking system. Forecasts can be provided for various aspects associated with the social networking system. In many cases, forecasts may be affected by seasonality. However, conventional approaches may not incorporate seasonality in providing forecasts. An improved approach rooted in computer technology can overcome the foregoing and other disadvantages associated with conventional approaches specifically arising in the realm of computer technology. Based on computer technology, the disclosed technology can provide forecasts that take seasonality into account. Seasonality can indicate one or more patterns that occur over time. Forecasts can be provided in connection with various aspects of the social networking system, such as growth, advertising, posts, revenue, etc. More specifically, forecasts can be provided for a metric associated with an aspect to be forecast. In one example, an aspect of the social networking system that can be forecast is growth, and growth-related metrics can include monthly active people (MAP), daily active people (DAP), etc. A growth model can be generated to predict growth associated with the social networking system. Growth can be limited by capacity and change points, and capacity and change points can be incorporated into the growth model. Capacity can indicate factors that can limit growth, such as a population size, a market size, etc. Change points can indicate sudden or abrupt changes in growth rates. A seasonality model can be trained to predict seasonality associated with growth associated with the social networking system. A combined model that predicts growth and seasonality can be generated based on the growth model and the seasonality model. For example, the growth model and the seasonality model can be fit iteratively to data in order to generate the combined model. The disclosed technology can generate one or more models based on machine learning techniques. Details relating to the disclosed technology are explained further below. In this manner, the disclosed technology can provide forecasts incorporating seasonality and provide more accurate forecasts associated with various aspects of the social networking system.

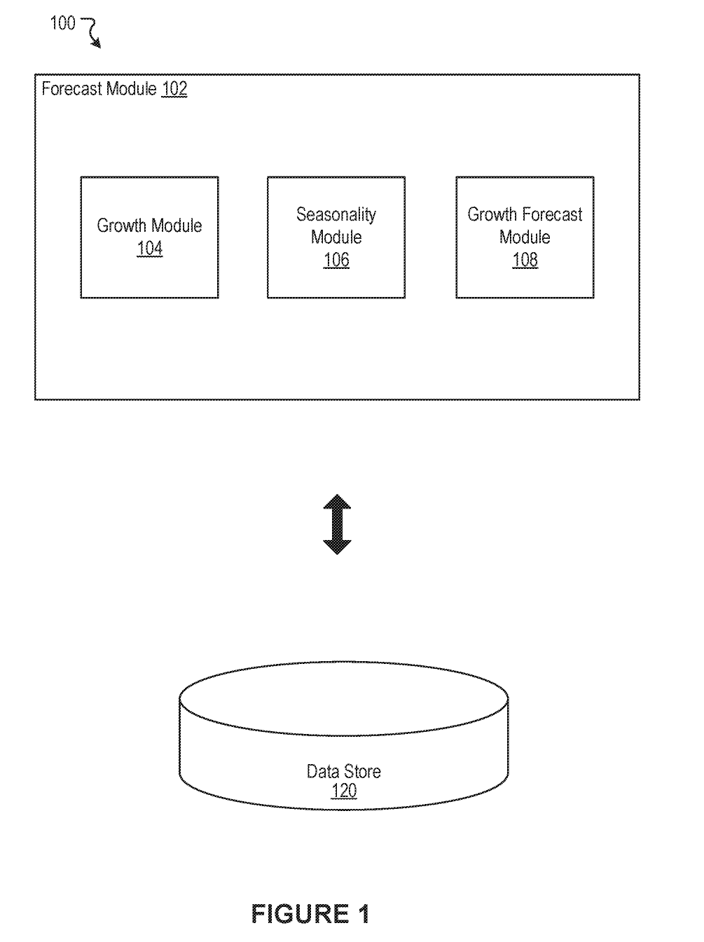

FIG. 1 illustrates an example system 100 including an example forecast module 102 configured to provide forecasts associated with a social networking system, according to an embodiment of the present disclosure. The forecast module 102 can include a growth module 104, a seasonality module 106, and a growth forecast module 108. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the forecast module 102 can be implemented in any suitable combinations.

The growth module 104 can model growth associated with the social networking system. For example, the growth module 104 can predict growth associated with the social networking system. A growth model can be provided based on machine learning techniques. The growth model can incorporate capacity data and change point data. The growth module 104 is described in more detail herein.

The seasonality module 106 can model growth associated with the social networking system. For example, the seasonality module 106 can predict seasonality associated with growth associated with the social networking system. A seasonality model can be provided based on machine learning techniques. The seasonality model can incorporate holiday and/or event data. The seasonality module 106 is described in more detail herein.

The growth forecast module 108 can forecast growth associated with the social networking system. For example, the growth forecast module 108 can provide forecasts for one or more growth-related metrics. A combined model based on the growth model and the seasonality model can be provided. Forecasts provided by the combined model can forecast growth while incorporating seasonality. The growth forecast module 108 is described in more detail herein.

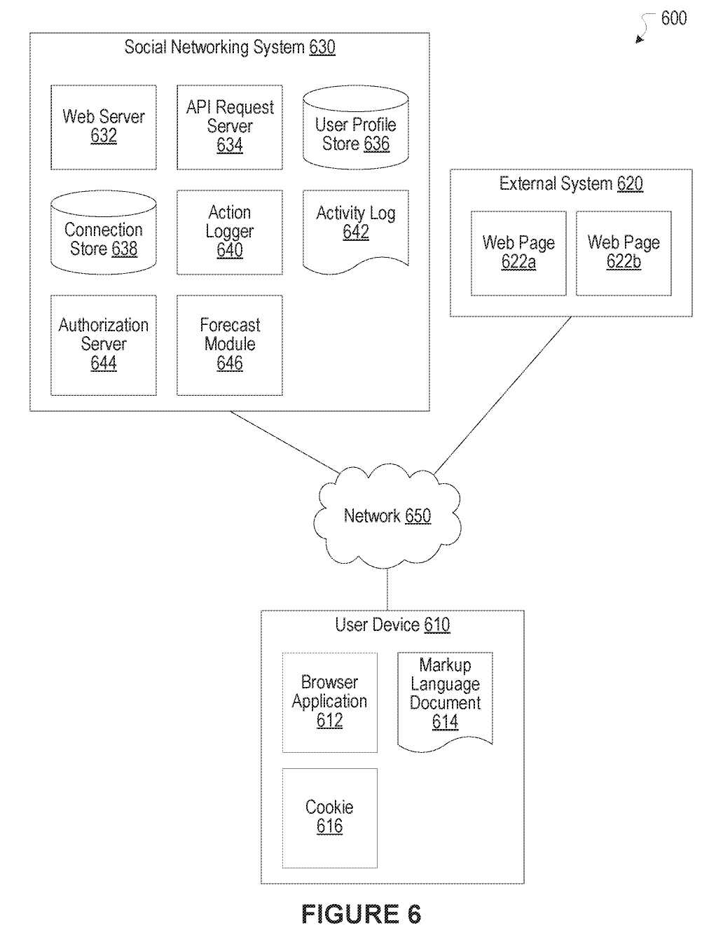

In some embodiments, the forecast module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the forecast module 102 can be, in part or in whole, implemented as software running on one or more computing devices or systems, such as on a server system or a client computing device. In some instances, the forecast module 102 can be, in part or in whole, implemented within or configured to operate in conjunction or be integrated with a social networking system (or service), such as a social networking system 630 of FIG. 6. Likewise, in some instances, the forecast module 102 can be, in part or in whole, implemented within or configured to operate in conjunction or be integrated with a client computing device, such as the user device 610 of FIG. 6. For example, the forecast module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the forecast module 102. The data maintained by the data store 120 can include, for example, information relating to models (e.g., growth models, seasonality models, combined models, etc.), components of models, forecasts or predictions, capacity data, change point data, holiday and/or event data, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the forecast module 102 can be configured to communicate and/or operate with the data store 120. In some embodiments, the data store 120 can be a data store within a client computing device. In some embodiments, the data store 120 can be a data store of a server system in communication with the client computing device.

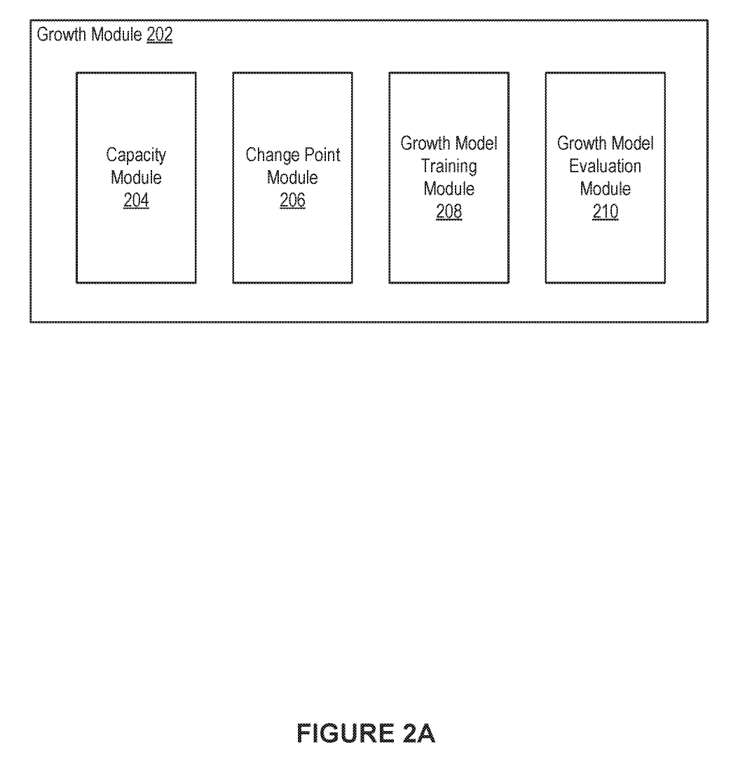

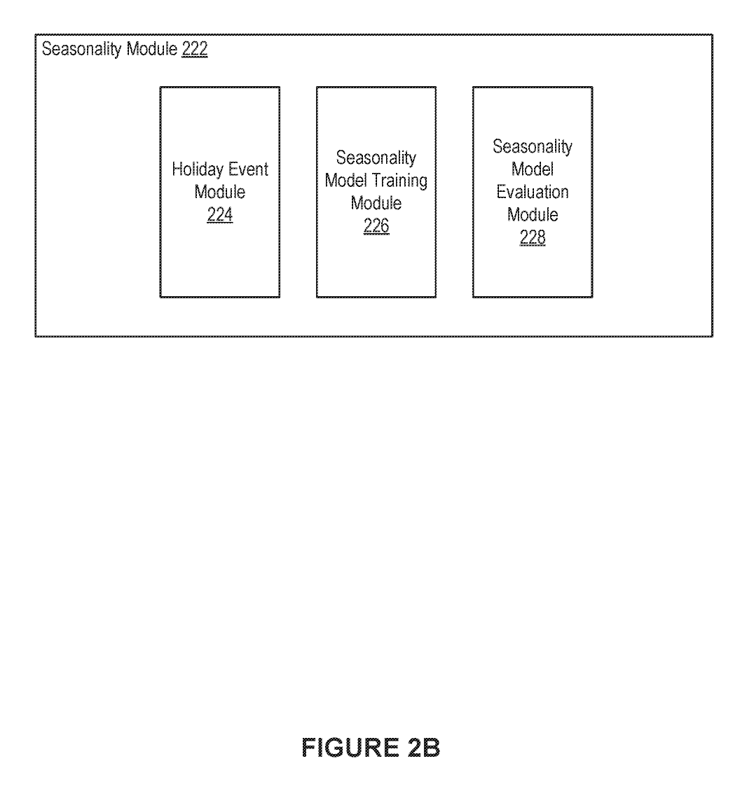

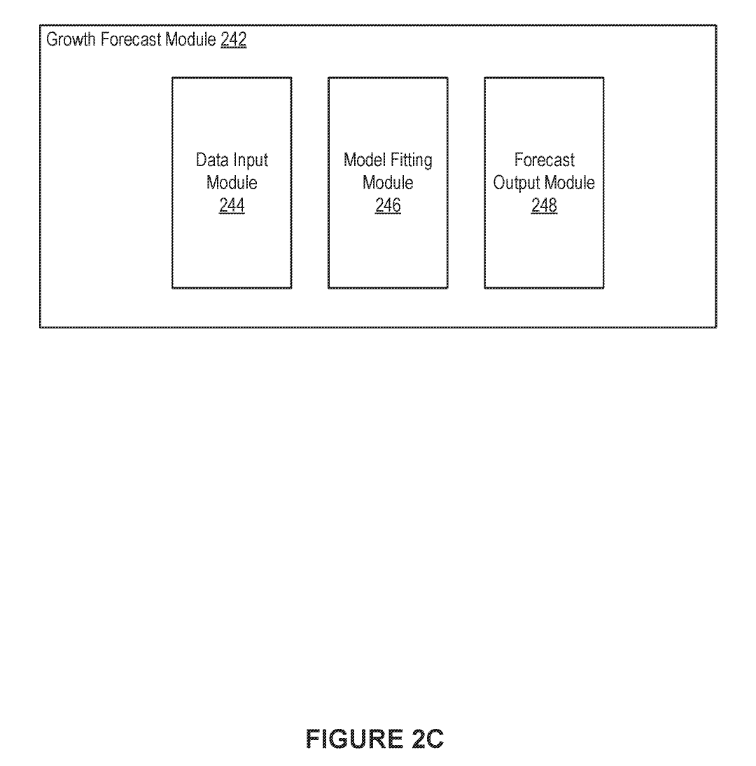

FIG. 2A illustrates an example growth module 202 configured to model growth associated with a social networking system, according to an embodiment of the present disclosure. In some embodiments, the growth module 104 of FIG. 1 can be implemented with the example growth module 202. As shown in the example of FIG. 2, the example growth module 202 can include a capacity module 204, a change point module 206, a growth model training module 208, and a growth model evaluation module 210.

Growth associated with the social networking system can indicate any type of growth associated with the social networking system. The disclosed technology is described in connection with growth of users of an application associated with the social networking system for illustrative purposes, and there can be many variations and possibilities. Growth can be determined for a population that meets certain criteria. Examples of criteria can include a geographical region of a user (e.g., a country, state, county, city, etc.), an age or age range of a user, etc. Many variations are possible. Growth can be represented by one or more generalized logistic curves. Generalized logistic curves can be S-shaped curves (e.g., Sigmoid curves).

Growth can be limited by capacities. For example, a population can have a total size, and growth can be capped by the total size. Capacities can relate to components of growth as explained below. Growth can also be affected by change points. Change points can represent points in time that can introduce a sudden or abrupt change in a growth rate. For example, change points can be associated with product releases, marketing campaigns, new features, etc. Capacities and change points are discussed in further detail below.

In certain embodiments, growth can be determined as follows:

population*(Internet adoption/population)*(MAP/Internet adoption)*(DAP/MAP)=DAP (1),

where population indicates a total population meeting certain criteria, Internet adoption indicates a level of Internet adoption for the population, MAP indicates monthly active people in the population who access the application, and DAP indicates daily active people in the population who access the application. DAP can be further divided into desktop only DAP, mobile only DAP, and desktop and mobile DAP. For example, desktop only DAP, mobile only DAP, and desktop and mobile DAP can be determined as follows:

DAP×% desktop DAP=desktop DAP (2)

DAP×% mobile DAP=mobile DAP (3)

DAP×% desktop-mobile DAP=desktop-mobile DAP (4),

where % desktop DAP indicates a percentage of daily active people who access the application only using desktop computers, % mobile DAP indicates a percentage of daily active people who access the application only using mobile devices, and % desktop-mobile DAP indicates a percentage of daily active people who access the application using both desktop computers and mobile devices. Equation (1) specifies certain components of growth: population, Internet adoption, DAP, and MAP. Each component of growth can be forecast separately. For example, each component of growth can be modeled and predicted using a separate machine learning model. Forecasting each component of growth separately is explained in detail below.

The capacity module 204 can provide capacity data associated with growth. For example, the capacity module 204 can specify one or more capacities associated with growth. Capacities can help provide more accurate forecasts since growth of users of the application can reach saturation at some point in time. For example, in theory, growth cannot extend beyond 100% of users in a population. A capacity can specify an upper bound for growth. A capacity can also specify a lower bound for growth, which can be zero in most cases. A capacity can be specified for a component of growth as appropriate. For example, if growth is being forecast for a population of Country 1 and a population of Country 2, a respective capacity can be specified for the population of Country 1 and the population of Country 2. In some embodiments, capacity data can be provided to the capacity module 204. In certain embodiments, the capacity module 204 can estimate or predict capacities based on a machine learning model. A machine learning model can be trained based on historical capacity data, and the trained machine learning model can be used to predict capacities in connection with growth. In some embodiments, capacities can be provided in the form of dates and corresponding capacity values.

The change point module 206 can provide change point data associated with growth. For example, the change point module 206 can specify one or more change points associated with growth. As explained above, change points can represent points in time that can introduce a sudden or abrupt change affecting growth. Typically, the shape of growth curves changes gradually, but after certain occurrences the shape of the growth curves can change quickly. Change points can identify one or more segments in growth data where growth rates can change abruptly (e.g., by an amount that exceeds a threshold value). A growth model can recognize portions of growth data marked by one or more change points as separate segments, for example, during training. Change points can help provide more accurate forecasts since portions of growth data associated with significantly different growth rates are not treated as continuous data. A growth model is explained in more detail below. In some embodiments, change point data can be provided to the change point module 206. In certain embodiments, the change point module 206 can estimate or predict change points based on a machine learning model. A machine learning model can be trained based on historical change point data, and the trained machine learning model can be used to predict change points in connection with growth. In some embodiments, change points can be provided in the form of dates.

The growth model training module 208 can train a machine learning model for growth based on growth data. The growth model training module 208 can generate a machine learning model to predict growth associated with the social networking system. The machine learning for predicting growth can be referred to as the “growth model.” The growth model can predict growth based on components of growth as discussed above, which include population, Internet adoption, MAP, and DAP. As explained above, each component of growth can be modeled and predicted using a respective machine learning model. Each component can be predicted separately and combined for the growth model. Components of growth can vary for different geographical regions (e.g., countries, states, counties, cities, etc.), and can be specified or predicted for each geographical region. For example, population, Internet adoption, DAP, and MAP can be specified or predicted for each country.

The population component can indicate a total population meeting certain criteria. For example, the population component can indicate a population in a particular geographical region, such as a country. In some embodiments, population data can be obtained from an external source. The population data from the external source can include predictions for populations (e.g., for a period of time in the future). In certain embodiments, the population component can be predicted based on a machine learning model. A machine learning can be trained based on historical population data, and the trained machine learning model can be used to predict the population component in connection with growth. The trained machine learning model can be incorporated into the growth model. The population component can be predicted based on the population data from the external source or the trained machine learning model, or both. A capacity can be specified for the population component. For example, a population may be expected to not increase above or decrease below a particular number, and the particular number can be specified as a capacity for the population component. A capacity for the population component can specify an upper bound or a lower bound.

The Internet adoption component can indicate a level of Internet adoption for a relevant population. The Internet adoption component can be specified as a percentage of the population component. For example, Internet adoption for a year can include a person who accesses the Internet at least once in that year by any means. In some embodiments, Internet adoption data can be obtained from an external source. For example, the Internet adoption data from the external source can include historical Internet adoption data, forecasts for Internet adoption, etc. In certain embodiments, the Internet adoption component can be predicted based on a machine learning model. A machine learning can be trained based on historical Internet adoption data, and the trained machine learning model can be used to predict the Internet adoption component in connection with growth. The trained machine learning model can be incorporated into the growth model. The Internet adoption component can be predicted based on Internet adoption data from the external source or the trained machine learning model, or both. A capacity can be specified for the Internet adoption component. In theory, Internet adoption can include 100% of people in a relevant population. However, not all people may use the Internet due to various factors, such as age, resources, etc. Accordingly, a capacity for the Internet adoption component can be specified to reflect a more accurate Internet adoption level. For example, people in an age range of 15-64 can be counted for Internet adoption. A capacity for the Internet adoption component can be specified as a percentage of the population component. A capacity for the Internet adoption component can specify an upper bound or a lower bound.

The MAP component can indicate monthly active people who access the application. The MAP component can be specified as a percentage of the Internet adoption component. The MAP component can be predicted based on a machine learning model. A machine learning can be trained based on historical MAP data, and the trained machine learning model can be used to predict the MAP component in connection with growth. The trained machine learning model can be incorporated into the growth model. A capacity can be specified for the MAP component. In theory, MAP can include 100% of people with Internet adoption. In order to provide a more accurate prediction, the MAP component can be capped at a historical maximum value of MAP for a population. A capacity for the MAP component can be specified as a percentage of the Internet adoption component. A capacity for the MAP component can specify an upper bound or a lower bound.

The DAP component can indicate daily active people who access the application. The DAP component can be specified as a percentage of the MAP component. The DAP component can be predicted based on a machine learning model. A machine learning can be trained based on historical DAP data, and the trained machine learning model can be used to predict the DAP component in connection with growth. The trained machine learning model can be incorporated into the growth model. A capacity can be specified for the DAP component. In theory, DAP can include 100% of MAP. In order to provide a more accurate prediction, the DAP component can be capped at a historical maximum value of DAP for a population. A capacity for the DAP component can be specified as a percentage of the MAP component. A capacity for the DAP component can specify an upper bound or a lower bound.

The growth model can predict MAP and DAP as metrics associated with growth. As explained above, the DAP component can be further categorized into desktop only DAP, mobile only DAP, and desktop and mobile DAP. Desktop only DAP, mobile only DAP, and desktop and mobile DAP can each be specified as a percentage of DAP. In some embodiments, percentages for desktop only DAP, mobile only DAP, and desktop and mobile DAP can each be predicted based on a machine learning model. In addition, a capacity can be specified for desktop only DAP, mobile only DAP, or desktop and mobile DAP, which can specify an upper bound or a lower bound.

The growth model can incorporate respective machine learning models for components of growth. For example, a prediction for each component can be incorporated into the growth model. The growth model training module 208 can train the growth model based on training data that includes historical growth data. For example, the training data can include data relating to growth, population, Internet adoption, MAP, DAP, etc. Features for training the growth model can be selected as appropriate. For example, the features can include components of growth as explained above. The growth model can be trained to determine weights or coefficients associated with features included in the growth model. The growth model can be based on regression techniques. As explained above, change points can indicate different segments in the training data that may be associated with dramatically varying growth rates, and the growth model can recognize each segment of the training data as a separate set of data during a training phase. Accordingly, the growth model can model growth rates with more granularity through use of change points. The growth model can be retrained based on new or updated training data. For example, if new growth data becomes available, the growth model training module 208 can train the growth model based on the new growth data. The growth model training module 208 can refine the growth model in order to achieve desired results.

The growth model evaluation module 210 can apply the trained growth model to determine growth associated with the social networking system. For example, the trained growth model can be applied to growth data to test the growth model prior to combining with a seasonality model to generate a combined growth forecast model. The growth model can be fit to growth data iteratively in order to generate the combined growth forecast model as explained below.

FIG. 2B illustrates an example seasonality module 222 configured to model seasonality associated with a social networking system, according to an embodiment of the present disclosure. In some embodiments, the seasonality module 106 of FIG. 1 can be implemented with the example seasonality module 222. As shown in the example of FIG. 2, the example seasonality module 222 can include a holiday event module 224, a seasonality model training module 226, and a seasonality model evaluation module 228.

The holiday event module 224 can provide holiday data and/or event data. Holidays and events can indicate occasions that can cause a dip or a spike in a growth curve. A holiday can refer to a regularly recurring occasion. An event can generally be a one-time occasion. Examples of holidays can include dates that fall on the same day every year (e.g., New Year's) or dates that fall on the same day of the week every year (e.g., Memorial Day, Labor Day, Thanksgiving, etc.). Since holidays are recurring occurrences, holidays can be projected into the future. In some cases, occasions that are not official holidays but are recurring can also be included in holiday data (e.g., social events, religious events, etc.). For example, Super Bowl and Oscars can affect growth and will probably recur ever year, so they can be included in holiday data and projected into the future. In some embodiments, holiday data and event data can be provided in the form of dates. Holidays and events can be specified for a particular geographical region, such as a country. For example, a list of default holidays for a country can be used. Seasonal effects due to holidays and/or events can be incorporated into a seasonality model.

The seasonality model training module 226 can train a machine learning model for seasonality based on seasonality data. The seasonality model training module 226 can generate a machine learning model to predict seasonality associated with growth associated with the social networking system. The machine learning model for predicting seasonality can be referred to as the “seasonality model.” The seasonality model training module 226 can train the seasonality model based on training data that includes historical seasonality data. For example, the training data can include data relating to growth and seasonal effects. Features for training the seasonality model can be selected as appropriate. The seasonality model can be trained to determine weights or coefficients associated with features included in the seasonality model. The seasonality model can be trained to detect weekly and/or yearly cycles. The seasonality model can be based on Fourier expansions. The seasonality model can be based on regression techniques. The seasonality model can be retrained based on new or updated training data. For example, if new seasonality data becomes available, the seasonality model training module 226 can train the seasonality model based on the new seasonality data. The seasonality model training module 226 can refine the seasonality model in order to achieve desired results.

The seasonality model evaluation module 228 can apply the trained seasonality model to determine seasonal effects affecting growth associated with the social networking system. The trained seasonality model can be applied to seasonality data in order to test the seasonality model prior to combining with a growth model to generate a combined growth forecast model. For example, seasonality data can be obtained by subtracting growth predicted by a growth model from growth data. The seasonality model can be fit to seasonality data iteratively in order to generate the combined growth forecast model as explained below.

FIG. 2C illustrates an example growth forecast module 242 configured to forecast growth associated with a social networking system, according to an embodiment of the present disclosure. In some embodiments, the growth forecast module 108 of FIG. 1 can be implemented with the example growth forecast module 242. As shown in the example of FIG. 2, the example growth forecast module 242 can include a data input module 244, a model fitting module 246, and a forecast output module 248.

The data input module 244 can obtain growth data for fitting a growth model and a seasonality model in order to generate a combined growth forecast model. The growth data can include historical growth data. For example, historical growth data can include data relating to growth, population, Internet adoption, MAP, DAP, etc.

The model fitting module 246 can fit the growth model and the seasonality model iteratively based on the obtained growth data. Initially, the model fitting module 246 can fit the growth model to the growth data. The growth model can predict growth associated with the social networking system, and the predicted growth can be subtracted from the growth data. What remains after subtracting the predicted growth from the growth data can be interpreted as seasonal effects and can be used as seasonality data to fit the seasonality model. This remaining data can be referred to as “remaining seasonality.” The remaining seasonality can be fit to the seasonality model. The seasonality model can predict seasonality associated with growth associated with the social networking system, and the predicted seasonality can be subtracted from the growth data. What remains after subtracting the predicted seasonality from the growth data can be referred to as “remaining growth,” and the remaining growth can be fit to the growth model. The process can repeat, and the growth model can predict growth associated with the social networking system, and the predicted growth can be subtracted from the growth data to obtain remaining seasonality. The remaining seasonality can be fit to the seasonality model. The seasonality model can predict seasonality associated with growth associated with the social networking system, and the predicted seasonality can be subtracted from the growth data to obtain remaining growth. The remaining growth can be fit to the growth model. The process can be performed iteratively as appropriate in order to refine the growth model and the seasonality model. The refined growth model and the seasonality model can be combined to generate a combined growth forecast model.

The forecast output module 248 can output forecasts for growth predicted by the combined growth forecast model. The combined growth forecast model can capture seasonal effects associated with growth and therefore provide forecasts that incorporate seasonality associated with growth. The forecast output module 248 can provide forecasts for growth for a specified period of time into the future. For example, the forecasts can be provided for the following year, following ten years, following twenty years, etc. In some embodiments, the forecast output module 248 can output forecasts for the MAP component and the DAP component of growth. For example, the DAP component can be forecast for each day included in the specified period or at least a portion of the specified period. The forecast output module 248 can further output forecasts for desktop only DAP, mobile only DAP, and desktop and mobile DAP categories. Forecasts can be provided for different geographical regions (e.g., countries, states, cities, etc.).

In the present disclosure, forecasts incorporating seasonality have been explained in connection with growth, but forecasts can be provided for any aspect associated with the social networking system or other systems. For instance, an underlying model for any appropriate aspect to be forecast can be used in place of the growth model. Examples of aspects that can be forecast can include advertising, posts, revenue, etc. Forecasts incorporating seasonality can be provided for any data that can be represented as a time series. Change points and/or capacity data can be considered as appropriate.

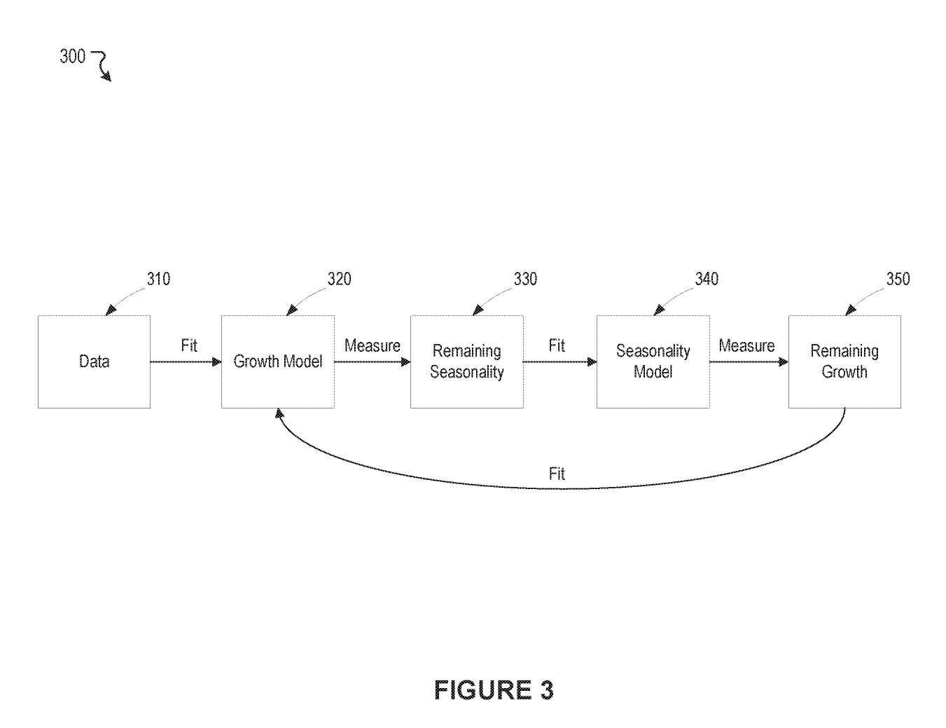

FIG. 3 illustrates an example scenario 300 for providing forecasts associated with a social networking system, according to an embodiment of the present disclosure. The example scenario 300 illustrates iterative fitting of a growth model and a seasonality model. Data 310 can be used to fit a growth model 320. For example, the data 310 can be historical growth data. The growth model 320 can predict growth associated with the social networking system. Remaining seasonality 330 can be obtained by subtracting the predicted growth by the growth model 320 from the data 310. The remaining seasonality 320 can be used to fit a seasonality model 340. The seasonality model 340 can predict seasonality associated with growth. Remaining growth 350 can be obtained by subtracting the predicted seasonality by the seasonality model 340 from the data 310. The remaining growth 350 can be used to fit the growth model 320. The growth model 320 can predict growth. Remaining seasonality 330 can be obtained by subtracting the predicted growth by the growth model 320 from the data 310. The remaining seasonality 330 can be used to fit the seasonality model 340. The seasonality model 340 can predict seasonality associated with growth. Remaining growth 350 can be obtained by subtracting the predicted seasonality by the seasonality model 340 from the data 310. The remaining growth 350 can be used to fit the growth model 320. The fitting of the growth model and the seasonality model can be repeated until the growth model and the seasonality model achieve desired prediction results.

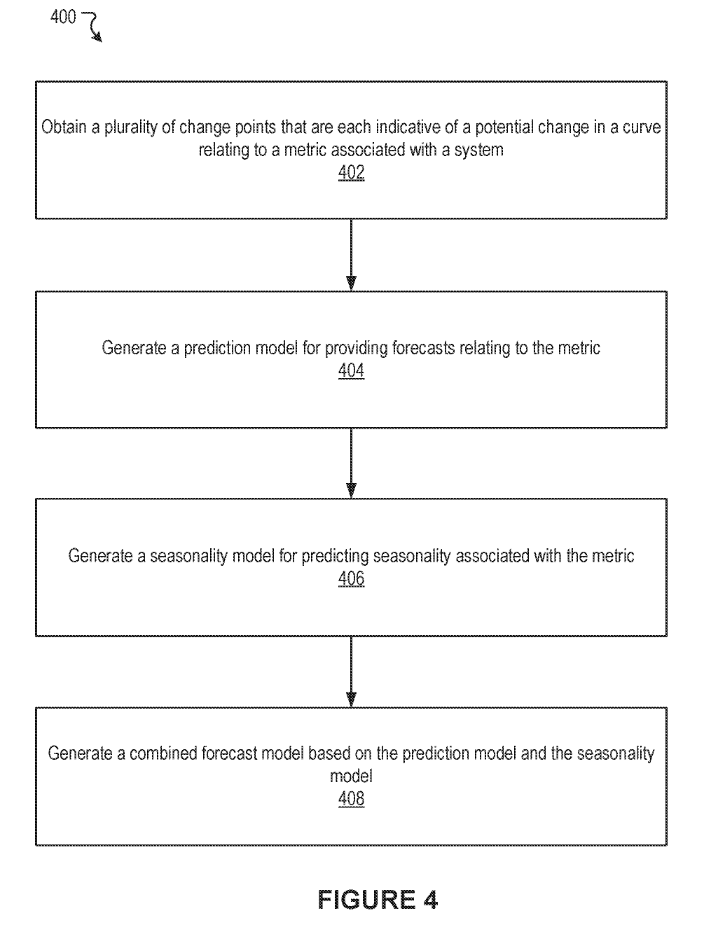

FIG. 4 illustrates an example first method 400 for providing forecasts associated with a social networking system, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can obtain a plurality of change points that are each indicative of a potential change in a curve relating to a metric associated with a system. At block 404, the example method 400 can generate a prediction model for providing forecasts relating to the metric. At block 406, the example method 400 can generate a seasonality model for predicting seasonality associated with the metric. At block 408, the example method 400 can generate a combined forecast model based on the prediction model and the seasonality model. Other suitable techniques that incorporate various features and embodiments of the present disclosure are possible.

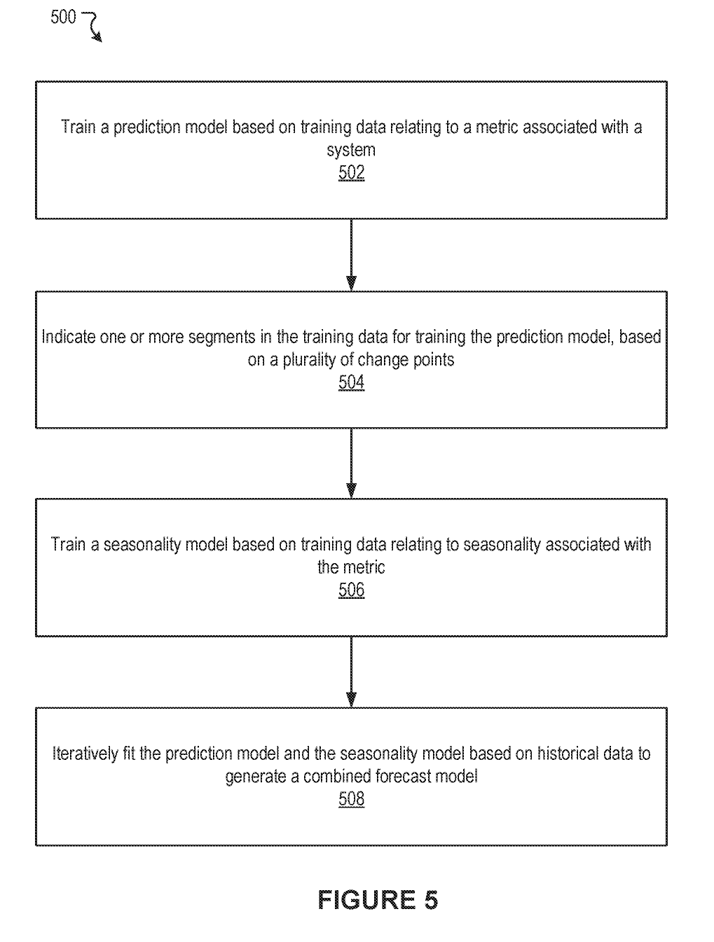

FIG. 5 illustrates an example second method 500 for providing forecasts associated with a social networking system, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can train a prediction model based on training data relating to a metric associated with a system. The prediction model can be similar to the prediction model explained in connection with FIG. 4. The metric can be similar to the metric explained in connection with FIG. 4. At block 504, the example method 500 can indicate one or more segments in the training data for training the prediction model, based on a plurality of change points. The plurality of change points can be similar to the plurality of change points explained in connection with FIG. 4. At block 506, the example method 500 can train a seasonality model based on training data relating to seasonality associated with the metric. The seasonality model can be similar to the seasonality model explained in connection with FIG. 4. At block 508, the example method 500 can iteratively fit the prediction model and the seasonality model based on historical data to generate a combined forecast model. The combined forecast model can be similar to the combined forecast model explained in connection with FIG. 4. In some embodiments, the metric can relate to a growth rate associated with growth of users of the system, and the system can be a social networking system. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a forecast module 646. The forecast module 646 can be implemented with the forecast module 102, as discussed in more detail herein. In some embodiments, one or more functionalities of the forecast module 646 can be implemented in the user device 610.

### Hardware Implementation

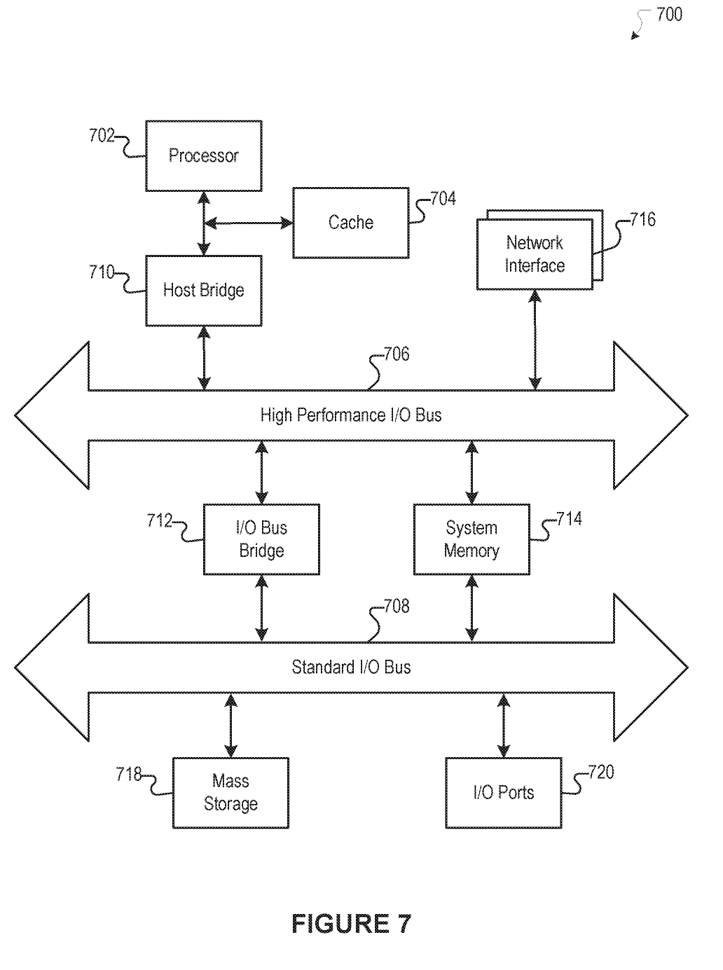

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing system, a plurality of change points that are each indicative of a potential change in a curve relating to a metric associated with a system;
generating, by the computing system, a prediction model for providing forecasts relating to the metric;
generating, by the computing system, a seasonality model for predicting seasonality associated with the metric; and
generating, by the computing system, a combined forecast model based on the prediction model and the seasonality model.

2. The computer-implemented method of claim 1, wherein the plurality of change points are provided as dates.

3. The computer-implemented method of claim 1, wherein the plurality of change points are determined based on a machine learning model.

4. The computer-implemented method of claim 1, wherein the prediction model is a machine learning model, and the method further comprises training the machine learning model based on training data relating to the metric.

5. The computer-implemented method of claim 4, wherein the plurality of change points indicate one or more segments in the training data for training the machine learning model.

6. The computer-implemented method of claim 1, wherein the seasonality model is a machine learning model, and the method further comprises training the machine learning model based on training data relating to seasonality associated with the metric.

7. The computer-implemented method of claim 1, further comprising obtaining a plurality of holidays and events that are each indicative of a potential change in the curve relating to the metric.

8. The computer-implemented method of claim 1, further comprising iteratively fitting the prediction model and the seasonality model based on historical data to generate the combined forecast model.

9. The computer-implemented method of claim 1, further comprising obtaining capacity data relating to one or more components included in the prediction model, wherein the forecasts relating to the metric are determined based on the one or more components.

10. The computer-implemented method of claim 1, wherein the metric relates to a growth rate associated with growth of users of the system, and wherein the system is a social networking system.

11. A system comprising:
at least one hardware processor; and
a memory storing instructions that, when executed by the at least one processor, cause the system to perform:
obtaining a plurality of change points that are each indicative of a potential change in a curve relating to a metric associated with a system;
generating a prediction model for providing forecasts relating to the metric;
generating a seasonality model for predicting seasonality associated with the metric; and
generating a combined forecast model based on the prediction model and the seasonality model.

12. The system of claim 11, wherein the prediction model is a machine learning model, and the method further comprises training the machine learning model based on training data relating to the metric.

13. The system of claim 12, wherein the plurality of change points indicate one or more segments in the training data for training the machine learning model.

14. The system of claim 11, wherein the seasonality model is a machine learning model, and the method further comprises training the machine learning model based on training data relating to seasonality associated with the metric.

15. The system of claim 11, wherein the instructions further cause the system to perform iteratively fitting the prediction model and the seasonality model based on historical data to generate the combined forecast model.

16. A non-transitory computer readable medium including instructions that, when executed by at least one hardware processor of a computing system, cause the computing system to perform a method comprising:
obtaining a plurality of change points that are each indicative of a potential change in a curve relating to a metric associated with a system;
generating a prediction model for providing forecasts relating to the metric;
generating a seasonality model for predicting seasonality associated with the metric; and
generating a combined forecast model based on the prediction model and the seasonality model.

17. The non-transitory computer readable medium of claim 16, wherein the prediction model is a machine learning model, and the method further comprises training the machine learning model based on training data relating to the metric.

18. The non-transitory computer readable medium of claim 17, wherein the plurality of change points indicate one or more segments in the training data for training the machine learning model.

19. The non-transitory computer readable medium of claim 16, wherein the seasonality model is a machine learning model, and the method further comprises training the machine learning model based on training data relating to seasonality associated with the metric.

20. The non-transitory computer readable medium of claim 16, wherein the method further comprises iteratively fitting the prediction model and the seasonality model based on historical data to generate the combined forecast model.
